(19) United States
(12) Patent Application Publication
(10) Pub. No.: US 2005/0025588 A1
(43) Pub. Date: Feb. 3, 2005

(54) Handpiece apparatus used for cutting tools

(76) Inventor: Timothy Effrem, Englewood, FL (US)

Correspondence Address: KENNETH G. LEMKE;PTIZER INC., 201 TABOR ROAD, MORRIS PLAINS, NJ, NJ, 07950, US

(21) Appl. No.: 10/627,724

(22) Filed: Jul. 28, 2003

(51) Int. Cl. B23B 45/00

(52) U.S. Cl. 408/127

(57) ABSTRACT

The present invention relates to a handpiece comprising of a shrouded wall having a chuck rotatably connected to the interior portion of the shrouded wall, wherein the shrouded wall includes a first portion which has a diameter of about 26.0 mm and the second portion has a diameter of about 25.4 mm.

### FIELD OF INVENTION

The present invention generally relates to a handpiece device used with cutting, drilling, milling and the like devices. More specifically, the present invention relates to a unique handpiece used with a flexible shaft assembly.

### BACKGROUND OF THE INVENTION

In handheld cutting tools, generally, a motor transfers its power to the handpiece via a flexible shaft. The handpiece is connected to the flexible shaft assembly either by industry standard connections (examples are quick-detach or slip joint) or it is permanently or semi-permanently fixed to the end of the flexible shaft assembly by various means.

Standard handpieces (i.e. Foredom model #30) utilize a standard style of 3-jaw key chuck. Typically this chuck is the Jacobs® #0 chuck (or clone) which adjusts to accept the smallest standard shank size (1/16″/1.6 mm) up to a maximum opening of 5/32″/4 mm. This means that the largest industry standard shank size accommodated for burrs, bits etc. is ⅛″/3.18 mm However an effective maximum chuck capacity of ⅛″/3.18 mm is a serious limitation. Because the most common sizes for larger shank burrs and bits are ¼″/6.35 mm (USA, North America and some other countries using the “English” standard) and 6 mm (Europe and other countries using the metric standard), users wishing to utilize burrs and bits with ¼″/6.35 mm or 6 mm shanks are not accommodated by the chuck used in this type of handpiece. Therefore, this requires the use of a separate handpiece to change to ¼″/6.35 mm or 6 mm. To keep the maximum diameter at 1″/25.4 mm, this handpiece utilizes collets accommodating only a single size i.e. ¼″/6.35 mm rather than a key type 3-jaw chuck. For example, to change from ¼″/6.35 mm to ⅛″/3.18 mm or any other size required additional parts (i.e. collet) and a time consuming collet change.

Any previous attempts to remedy this deficiency would have faced certain obstacles. For a design to work, at least one entire end plus the majority of the exterior diameter of the handpiece must remain at 1″/25.4 mm +/−in order for it to fit into various standard handpiece holders, jigs and fixtures. At the same time the exterior size must be minimized for ease of handling when used freehand. In prior years, no ¼″/6.35 mm capacity adjustable 3-jaw key type chucks existed with an outside diameter small enough to be shrouded (guarded) within the walls of the handpiece, without increasing the exterior dimensions to detrimental proportions for freehand use. Therefore the end result would have been a handpiece with an exterior dimension that would be too large (i.e. greater than 1″) to fit into various standard handpiece holders, jigs and fixtures. Additionally, its diameter would be too large for most users to find acceptable for freehand use.

### SUMMARY OF THE INVENTION

The present invention remedies the deficiencies of the prior art mentioned above and provides other advantages.

The present invention provides, amongst other advantages, a handpiece for flexible shaft machines with a shrouded/guarded adjustable 3-jaw key type chuck having an effective capacity of 0-6.35 mm. Furthermore, the present invention provides a handpiece that is able to accept all standard shank sizes from at least 1/16″/1.6 mm to ¼″/6.35 mm, which greatly increases the utility of the handpiece over the prior art.

The present invention accomplishes the above advantages by having a handpiece which comprises a shrouded/guarded adjustable 3-jaw key type chuck with up to at least 6.35 mm capacity that includes a stepped exterior diameter dimension which corresponds with various standard handpiece holders, jigs and fixtures while retaining a weight and size ideal for freehand use.

### BRIEF DESCRIPTION OF THE DRAWINGS

The foregoing and additional features and characteristics of the present invention will become more apparent from the following detailed description considered with reference to the accompanying drawing figures in which like reference numerals designate like elements.

FIG. 1 is a sectional-side view of the embodiment of the handpiece apparatus; and

FIG. 2 is a side view of the chuck; and

FIG. 3 is a side view of the key.

### DETAILED DESCRIPTION OF THE PRESENT INVENTION

The present invention relates to a unique handpiece device used to secure various size and type bits. In an exemplary embodiment, the present invention relates to a handpiece that is connected to a flexible shaft assembly. The flexible shaft, which is not shown, connects a motor to the handpiece, so that the motor may power the handpiece and its attachment. The flexible shaft further allows the user to easily move the handpiece and attached bit to various angles and positions as desired by the user. Furthermore, a user may hold the handpiece device with their hand during use of the device. This allows for greater control and precision for the user.

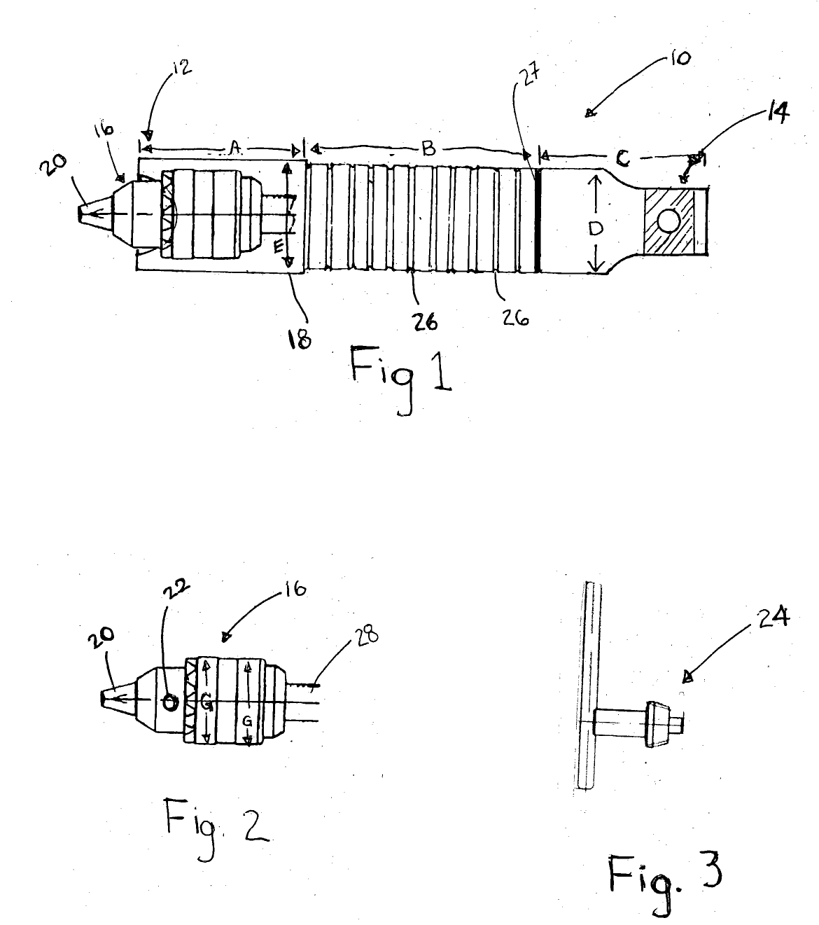

As discussed in greater detail, FIGS. 1 and 2 depict an exemplary embodiment of the handpiece device 10. The handpiece comprises a chuck 16 located within a shrouded wall 18. The chuck 16 is connected to the spindle 28 through a standard taper connection. The spindle 28 includes a receiving end (the end opposite to the one connected to the chuck) which is coupled with the motor. The motor drives the spindle and chuck assembly. The handpiece 10 device has a general cylindrical shape with a first end 12, and a second end 14 located opposite of the first end 12.

Located on the first end 12 of the handpiece 10 is a chuck 16 which is rotatable connected to the interior wall portion of the shrouded wall 18. In the exemplary embodiment, the chuck 16 protrudes out of the shrouded wall 18 so that the jaws 20 of the chuck 16 are exposed and may be accessed by the user. However, it should be appreciated that other embodiments may be used, for example, wherein the chuck is covered by the shroud/guard except the open portion where the jaws are exposed. In the exemplary embodiment, the chuck is a three-jaw chuck which is able to secure a bit (not shown) to the handpiece. As known to one skilled in the art, the chuck includes an opening 22 which is able to receive a key 24 (as shown in FIG. 3). The key may be rotated clockwise or counter-clockwise to open or close the jaws of the chuck and to secure the jaws around bits having various size diameters. In the exemplary embodiment, the 3-jaw chuck has a 0 to 1/4 inch capacity.

The shrouded wall may be made of aluminum, graphite, titanium or other suitable materials. Generally, the chuck is made from a durable steel alloy. One of the purposes of the shrouded wall is to provide protection from the chuck which is revolving at high speeds and can injure the user hand if his hand comes in contact with the chuck during use. Therefore, in the exemplary embodiment at least a portion of the chuck is covered by the shrouded wall.

Referring to FIG. 1, the dimensions of the handpiece 10 will be given. Toward the first end of the handpiece 10, the shrouded wall 18 includes a first portion having a length A which may vary depending on the user's desire. In the exemplary embodiment this first portion is a non-grooved portion, 40 mm in length. It should be noted that the length of portion A can vary depending on the user's desire. Furthermore, in the exemplary embodiment the length ranges from about 30 mm to above. In the preferred embodiment the length A is 35 mm to 45 mm. This portion of the shrouded wall 18 having length A has a diameter E which can range from about 25.5 mm to above, but preferably is about 26 mm.

Next to the first portion of the shrouded wall 18 is a second portion. In the exemplary embodiment the second portion includes a plurality of grooved ridges 26. These ridges 26 can serve several purposes which are known to one skilled in the art. These ridges allow the user to have a better grip of the handpiece device 10 during use and these ridges also increase the air surface area thereby cooling the handpiece. Furthermore, small ball bearings (not shown) which allow the chuck member to rotate within the shrouded wall 18 could be located below the ridges to take advantage of the cooling properties offered by the ridges. The length B of the second portion can vary in length from about 40 mm to about 85 mm, however in the exemplary embodiment the second portion has a length of about 62 mm. Furthermore, the second portion B has a diameter D which is less then the diameter of the first portion. The second portion has a diameter ranging from about 25.2 mm to about 25.6 mm, but in the preferred embodiment the diameter is about 25.4 mm. Therefore, the present invention provides a unique step design between the first portion A and the second portion B to accommodate for the slightly larger diameter chuck the prior art failed to accommodate or appreciate.

Another unique feature of the present invention is that the shrouded wall 18 has a thickness in the range of about 0.7 mm to about 1.2 mm, but in an exemplary embodiment the thickness is about 0.7 mm-0.8 mm. Furthermore, the chuck 16 has an outside diameter G in the range of about 23.0 mm to 24.6 mm. However, in the exemplary embodiment the outside diameter is about 23.7 mm.

A third portion C of the shrouded wall 18 is located at the second end 14 of the shrouded wall 18. The third portion is the flexible shaft connection area. Furthermore, the third portion is attachable connected to the second portion. The third portion may be threaded to communicate and be secured in the second portion. In the exemplary embodiment, the third portion C has a length of 35 mm. However, the shape and dimensions of this area may vary depending on the user's desire. For example the handpiece may be connected to the flexible shaft assembly either by industry standard connections, e.g. quick-detach or slip joint) or it is permanently or semi-permanently fixed to the end of the flexible shaft assembly by various means known to one skilled in the art.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A handpiece used with flexible shaft assemblies, the handpiece comprises:
a shrouded wall having a first end and a second end adapted to receive a connection device, and the shrouded wall has a generally cylindrical shape;
a chuck assembly which is rotatable connected to the interior of the shrouded wall portion; and
wherein a first portion of the shrouded wall has a diameter between about 25.5 mm to above.

2. The handpiece as claimed in claim 1, wherein the length of the first portion is in the range of about 35 mm to about 45 mm.

3. The handpiece as claimed in claim 1, wherein the length of the first portion is about 40 mm.

4. The handpiece as claimed in claim 1, wherein the diameter of the first portion is about 26 mm.

5. The handpiece as claimed in claim 1, wherein the thickness of the shrouded wall is in the range of about 0.7 mm to about 1.2 mm.

6. The handpiece as claimed in claim 1, wherein the thickness of the shrouded wall is about 0.7 mm-0.8 mm.

7. The handpiece as claimed in claim 1, wherein a second portion of the shrouded wall located between the first end and the second end includes a plurality of grooves or ridges.

8. The handpiece as claimed in claim 7, wherein the second portion has a length in the range of about 40 mm to about 85 mm.

9. The handpiece as claimed in claim 7, wherein the second portion has a length of about 62 mm.

10. The handpiece as claimed in claim 7, wherein the second portion has a diameter ranging from about 25.2 mm to about 25.6 mm.

11. The handpiece as claimed in claim 7, wherein the second portion has a diameter of about 25.4 mm.

12. The handpiece as claimed in claim 1, wherein the chuck includes a plurality of jaws which are able to secure a bit.

13. A handpiece used with flexible shaft assemblies, the handpiece comprises:
a shrouded wall having a first end and a second end which is adapted to receive a the flexible shaft assembly, and the shrouded wall has a generally cylindrical shape;
a chuck assembly which is rotatable connected to the interior of the first end of the shrouded wall portion and protrudes out of the shrouded wall so that the teeth of the chuck are able to receive a bit
a first portion of the shrouded wall located at the first end has a diameter in the range of about 25.5 mm to about 27.0 mm; and
a second portion of the shrouded wall located between the first end and the second end includes a plurality of grooves or ridges and has a diameter in the range of about 40 mm to about 85 mm.

14. A handpiece used with a flexible shaft assembly, the handpiece comprises:
a shrouded wall having a first end and a second end;
a 3-jaw chuck assembly which is rotatably connected to the interior of the first end of the shrouded wall portion and a plurality of jaws which are able to receive a bit; and
wherein the opening of the chuck jaws may be adjusted by a chuck key and the chuck has an effective capacity of about 5 mm to above.

15. The handpiece as claimed in claim 14, wherein a first portion of the shrouded wall, which is located near the first end, has a diameter of about 25.9 mm to above

16. The handpiece as claimed in claim 14, wherein the shrouded wall includes a second portion located between the first end and the second end and includes a plurality of grooves or ridges.

17. The handpiece as claimed in claim 16, wherein the second portion has a diameter ranging from about 25.2 mm to about 25.6 mm.

18. A handpiece used with a flexible shaft assembly, the handpiece comprises:
a shrouded wall having a first end and a second end;
a 3-jaw chuck assembly which is rotatably connected to the interior of the first end of the shrouded wall portion and a plurality of jaws which are able to receive a bit; and
wherein at least a portion of the chuck is covered by the shrouded wall and the chuck has an effective capacity of about 5 mm to above.

19. The handpiece as claimed in claim 18, wherein the 3-jaw chuck has an outer diameter in the range of about 23.0 mm to about 24 mm.
